(19) United States
(12) Patent Application Publication
(10) Pub. No.: US 2007/0040376 A1
(43) Pub. Date: Feb. 22, 2007

(54) Installation structure of suction hose for upright type vacuum cleaner

(75) Inventor: Im Suk Choi, Incheon (KR)

Correspondence Address: NATH & ASSOCIATES PLLC, 112 South West Street, Alexandria, VA, 22314, US

(73) Assignee: Daewoo Electronics Corporation, Seoul (KR)

(21) Appl. No.: 11/504,587

(22) Filed: Aug. 16, 2006

(30) Foreign Application Priority Data
Aug. 18, 2005 (KR) 10-2005-75735

(51) Int. Cl. A47L 9/00; A47L 5/00; A47L 9/24; F16L 27/00

(52) U.S. Cl. 285/275; 15/334; 285/7; 285/903; 285/272

(57) ABSTRACT

Disclosed herein is an installation structure of a suction hose for an upright type vacuum cleaner. The installation structure comprises a mounting part provided at either end of the suction hose and formed of a corrugated pipe having a thread shape, a pipe-shaped connecting member secured at one end to one side of the mounting part, an adapter having a securing protrusion formed on an outer surface thereof, and to which the connecting member is latched and secured so as to be restricted in axial movement while being permitted to rotate in a circumferential direction, and a receipt part to which the adapter having the securing protrusion formed thereon is inserted and secured. With this structure, the suction hose has a 360-degree rotation structure so that it is prevented from being twisted during a cleaning operation, thereby ensuring convenient cleaning while providing an appealing appearance.

### BACKGROUND OF THE INVENTION

1. Field of the Invention

The present invention relates to a vacuum cleaner, and, more particularly, to an installation structure of a suction hose for an upright type vacuum cleaner, which enables the suction hose applicable to both the upright type vacuum cleaner and a canister type vacuum cleaner to be installed such that, when the suction hose is subjected to a twisting force, the suction hose is rotated without being separated from the vacuum cleaner, thereby releasing the twisting force.

2. Description of the Related Art

In general, various types of vacuum cleaners are used to remove dust and other foreign substances on furniture, floor, carpets or the like in a room.

The vacuum cleaners serve to suck and remove the dust or the other foreign substances via a suction force from a dust collecting motor installed therein, and can be classified into a canister type vacuum cleaner and an upright type vacuum cleaner.

The canister type vacuum cleaner comprises a main body mounted on wheels, a suction hose to suck dust and other foreign substances into the main body, a suction force generating means such as a suction fan positioned in the main body, a motor positioned in the main body to drive the suction force generating means, a replaceable dust container positioned in the main body to filter the dust and the other foreign substances from air sucked into the main body, a main brush and a suction nozzle positioned at a free end of the suction hose.

The upright type vacuum cleaner is constructed similar to the canister type vacuum cleaner, and has a suction brush unit positioned below a main body of the vacuum cleaner and serving to suck dust and other foreign substances from objects to be cleaned.

FIG. 1 is a perspective view illustrating a conventional upright type vacuum cleaner.

Referring to FIG. 1, the upright type vacuum cleaner comprises a main body 11 standing upright, a suction brush unit 12 installed horizontally to a lower end of the main body 11 so as to move along a cleaning target surface, and a handle 13 connected with an upper end of the main body 11.

The main body 11 of the vacuum cleaner is provided at an upper portion with a dust collecting chamber which has a dust filter detachably installed thereto, and at a lower portion with a motor driving chamber in which a motor as a driving source is installed.

The upright type vacuum cleaner constructed as above generally has a high suction power, and is used to clean the carpet, the floor, and the like.

When realizing other utilities of the upright type vacuum cleaner, a furniture brush 15, a pipe 16 for small openings, and the like are mounted to a rear side of the main body 11. If a user separates one end of the suction hose 14 from the upright type vacuum cleaner, and mounts the furniture brush 15 or the pipe 16 for small openings thereon, the vacuum cleaner can be used to clean the ceiling and the furniture of the room as well as the floor.

For the upright type vacuum cleaner constructed as above, when the motor is driven, a strong suction force is generated from the suction brush unit 12, and causes air containing dust and various foreign substances on the cleaning target surface to be sucked into the main body 11 through the suction brush unit 12. The sucked air is discharged to the motor driving chamber through the dust filter installed in the dust collecting chamber of the main body 11.

Typically, when the vacuum cleaner is used as in the form of the upright type, the suction hose 14 is connected with a suction port of the suction brush unit 12, whereas, when the vacuum cleaner is used as in the form of the canister type, the suction hose 14 is connected at one end with the handle.

New types of vacuum cleaner applicable to both the upright type and the canister type have been recently developed as described above. In this regard, if the vacuum cleaner is operated in the form of the canister type, the user holds the handle connected with the suction hose 14, both ends of which are immobilized, during a cleaning operation, so that the suction hose 14 is twisted, causing some burdens to the user's wrist and lowering cleaning efficiency.

In addition, whenever the suction hose 14 is assembled, since it must be accurately aligned with corresponding components in terms of directionality due to its different coupling structures at both ends, assembling efficiency is also lowered. Accordingly, there is a need for an improved vacuum cleaner solving the problems.

### SUMMARY OF THE INVENTION

Therefore, the present invention has been made in view of the above problems of the conventional vacuum cleaner in that, during a cleaning operation with the vacuum cleaner, the suction hose is twisted, causing some burdens to the user's wrist while providing an unappealing appearance, and it is an object of the present invention to provide an installation structure of a suction hose for an upright type vacuum cleaner, which can solve the problems.

It is another object of the present invention to provide the installation structure of the suction hose for the upright type vacuum cleaner, which permits easy mounting of the suction hose.

According to an aspect of the present invention, the above and other objects can be accomplished by the provision of an installation structure of a suction hose for an upright type vacuum cleaner comprising a main body having a suction module installed therein, a dust collecting unit to suck dust and foreign substances, and a handle, the suction hose being connected at one end with the main body and at the other end with the dust collecting unit, the installation structure comprising: a mounting part provided at either end of the suction hose and formed of a corrugated pipe having a thread shape; a pipe-shaped connecting member secured at one end to one side of the mounting part; an adapter having a securing protrusion formed on an outer surface thereof, and to which the connecting member is latched and secured so as to be restricted in axial movement while being permitted to rotate in a circumferential direction; and a receipt part to which the adapter having the securing protrusion formed thereon is inserted and secured.

Preferably, the connecting member has threads formed on an inner surface of one end thereof such that the mounting part is fastened to the one end of the connecting member.

Preferably, the connecting member has a latching groove formed circumferentially on an outer surface thereof, and the adapter has a latching protrusion formed on an inner surface of the adapter such that the latching protrusion is inserted and mounted to the latching groove.

Preferably, the receipt part comprises a recessed guide slanted in a funnel shape to guide insertion of the securing protrusion into a mounting hole of the receipt part.

Preferably, the handle has a mounting hole formed therein and having an arc-shaped guide hole communicated therewith.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating a conventional upright type vacuum cleaner;

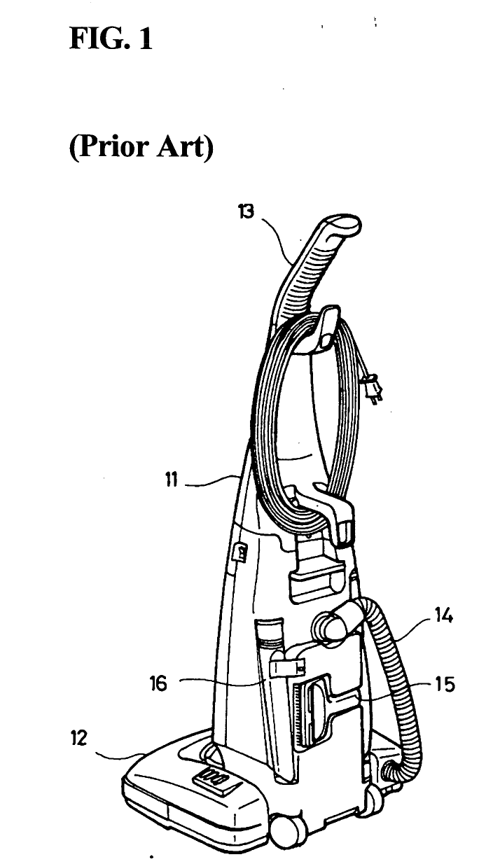

FIG. 2 is a perspective view illustrating a vacuum cleaner comprising a suction hose installation structure according to one embodiment of the present invention;

FIG. 3 is a side view of FIG. 2;

FIG. 4 is a perspective view illustrating the suction hose installation structure according to the embodiment of the present invention;

FIG. 5 is a side view of FIG. 4;

FIG. 6 is a side sectional-view illustrating an assembling state of the suction hose installation structure shown in FIG. 4;

FIG. 7 is a view illustrating an installation state of the suction hose according to the embodiment of the present invention when using the vacuum cleaner in the form of a canister type vacuum cleaner;

FIG. 8 is a view illustrating a state before the suction hose according to the embodiment of the present invention is coupled to a main body of the vacuum cleaner; and

FIG. 9 is a view illustrating a state after the suction hose according to the embodiment of the present invention is coupled to a main body of the vacuum cleaner.

### DESCRIPTION OF THE PREFERRED EMBODIMENTS

Preferred embodiments of the present invention will be described in detail with reference to the accompanying drawings as follows.

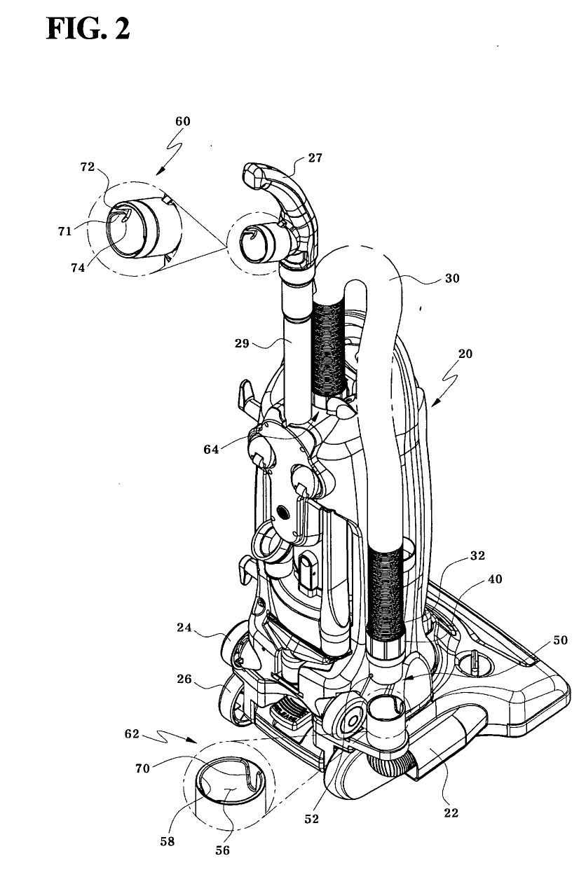

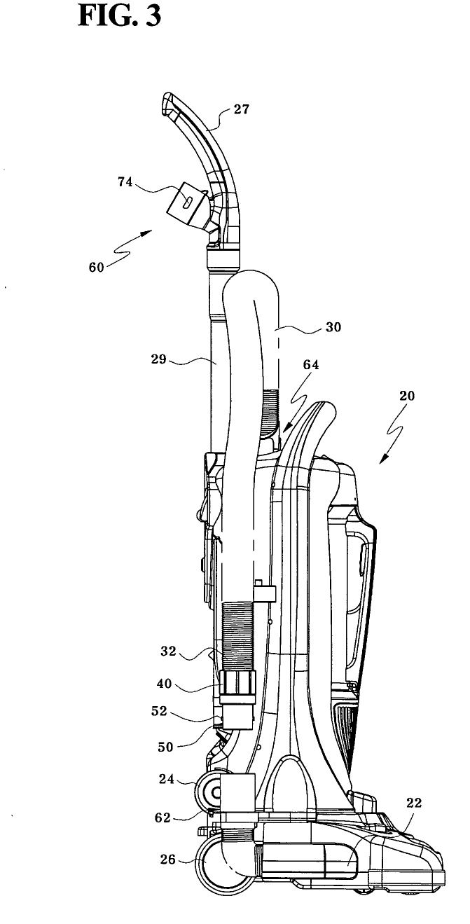

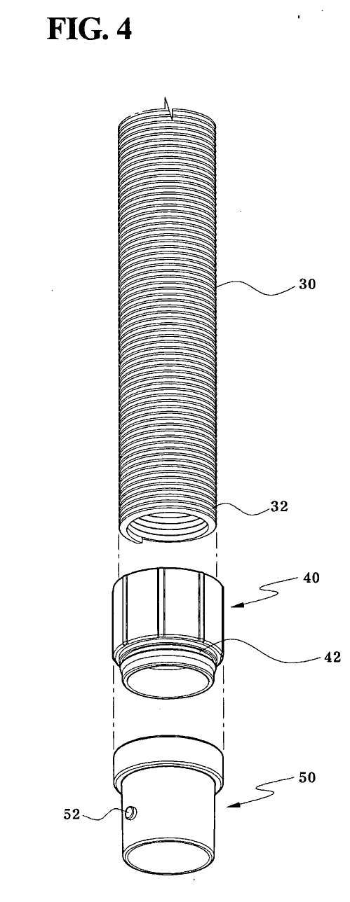

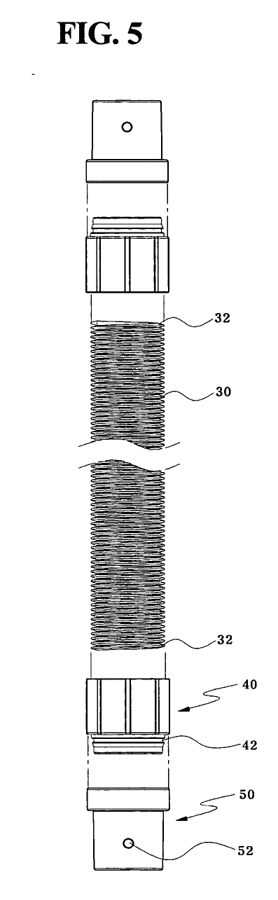

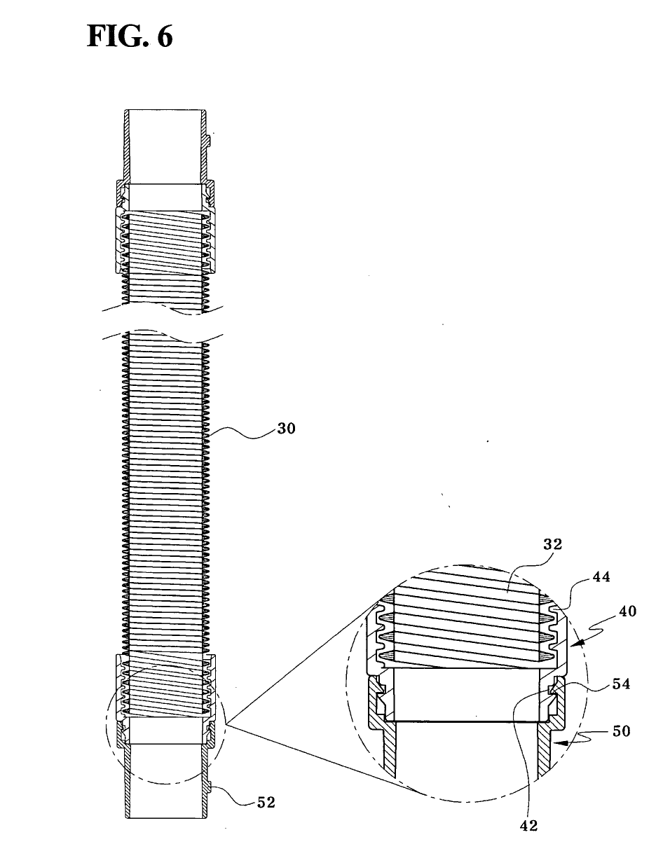

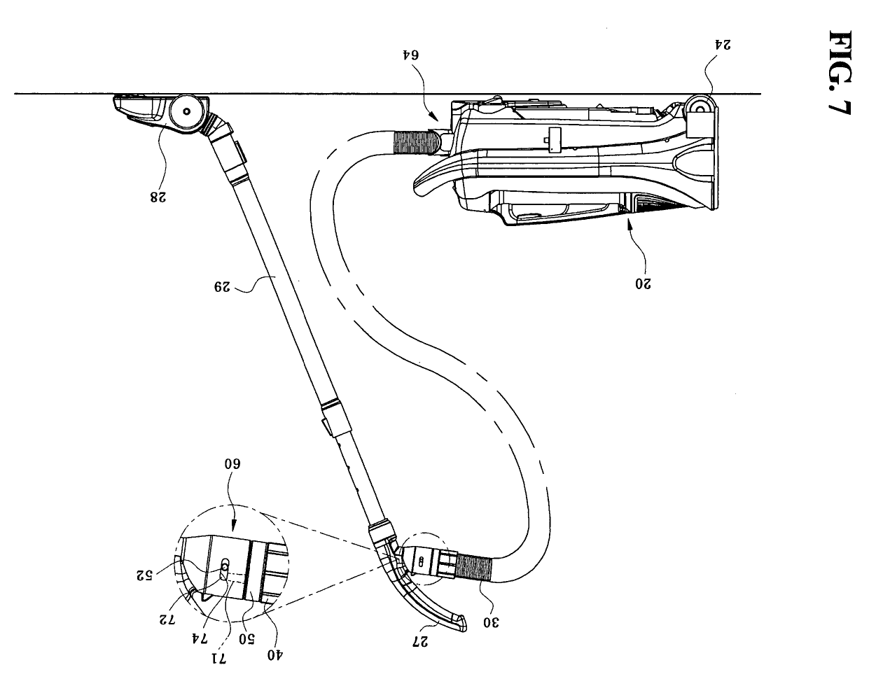

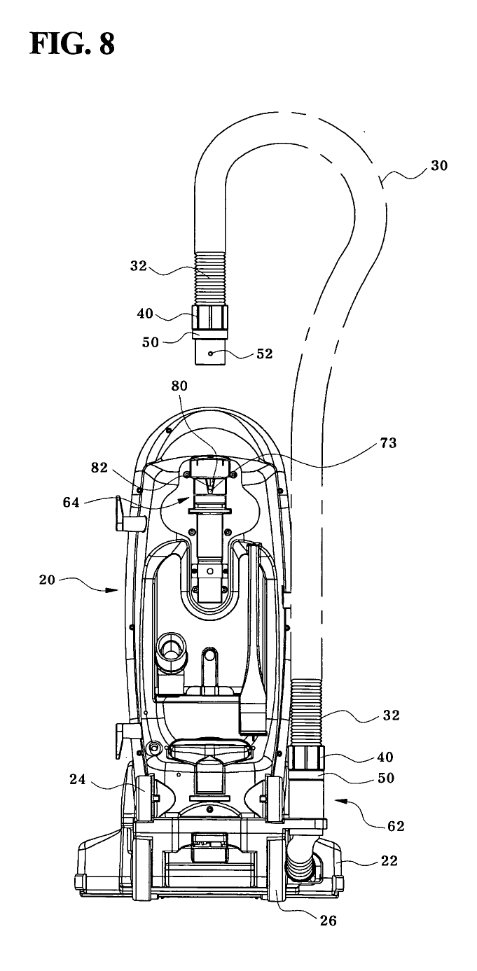

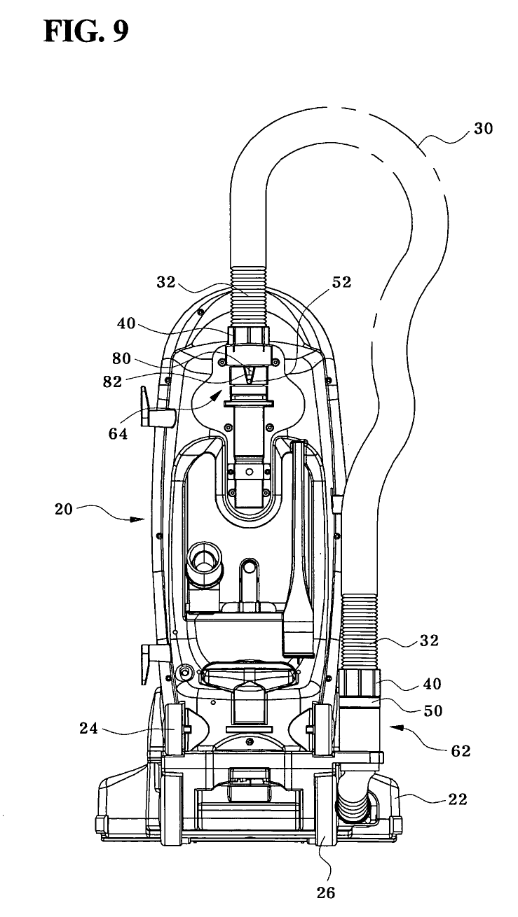

FIG. 2 is a perspective view illustrating a vacuum cleaner comprising a suction hose installation structure according to one embodiment of the present invention, FIG. 3 is a side view of FIG. 2, FIG. 4 is a perspective view illustrating the suction hose installation structure according to the embodiment of the present invention, FIG. 5 is a side view of FIG. 4, FIG. 6 is a side sectional-view illustrating an assembling state of the suction hose installation structure shown in FIG. 4, FIG. 7 is a view illustrating an installation state of the suction hose according to the embodiment of the present invention when using the vacuum cleaner in the form of a canister type vacuum cleaner, FIG. 8 is a view illustrating a state before the suction hose according to the embodiment of the present invention is coupled to a main body of the vacuum cleaner, and FIG. 9 is a view illustrating a state after the suction hose according to the embodiment of the present invention is coupled to a main body of the vacuum cleaner.

Referring to FIGS. 2 and 3, an upright type vacuum cleaner comprises a main body 20, a suction brush unit 22 detachably mounted to a lower side of the main body 20, and a suction module including a motor positioned in the main body 20.

The main body 20 is provided with assistance wheels 24 which allow the vacuum cleaner to be used with the main body 20 laid on a floor of a room, and the suction brush unit 22 is provided with main wheels 26 which are used during a cleaning operation.

A handle 27 of the vacuum cleaner is detachably mounted to the main body 20, and is connected with a suction pipe 29.

The vacuum cleaner further comprises a suction hose 30, one end of which is connected with the main body 20, and the other end of which is connected with the suction brush unit 22 positioned under the main body 20 or with the handle 27 to which the suction pipe 29 is coupled.

An installation structure of the suction hose 30 will be described with reference to FIGS. 4 to 6.

For the installation structure, the flexible suction hose 30 comprises a mounting part 32, which is formed at either end of the suction hose 30, and made of a corrugated pipe having threads formed thereon.

For the installation structure, the suction hose 30 is provided with a pipe-shaped connecting member 40, which has fastening threads 44 formed on an inner surface of one end of the connecting member 40 such that the mounting part 32 is fastened into the one end of connecting member 40, and a latching groove 42 formed circumferentially on an outer surface of the other end of the connecting member 40.

The suction hose 30 is further provided with an adapter 50, which has a latching protrusion 54 formed on an inner surface of the adapter 50 such that the latching protrusion 54 is inserted and mounted into the latching groove 42 of the connecting member 40 so as to prevent the connecting member 40 from moving in an axial direction and from being separated from an associated component while allowing a circumferential rotation of the connecting member 40, and which has securing protrusions 52 formed on an outer surface of the adapter 50. With this structure, the mounting part 32 of the suction hose 30, the connecting member 40, and the adapter 50 are sequentially assembled.

The installation structure is further provided with a pipe-shaped receipt part into which the adapter 50 is inserted and secured. The receipt part has a receipt opening 56, which defines an air passage and is formed at either side 58 with a recessed guide 70 slanted in a funnel shape to guide insertion of an associated securing protrusion 52 of the adapter 50 thereinto.

A brush receipt part 62 formed on the suction brush unit 22, a handle receipt part 60 formed on the handle 27, and a main body receipt part 64 formed on the main body 20 have the configuration of the receipt part of the installation structure according to the present invention as described above.

In the embodiment of the present invention, the brush receipt part 62 is not formed with a mounting hole for inserting the securing protrusion 52 in order to prevent sucked air from flowing out therethrough. However, the present invention is not limited to this structure, and, if needed, the brush receipt part 62 may be formed with the mounting hole as another embodiment.

Among the receipt parts, the handle receipt part 60 formed on the handle 27 is provided at either end with an arc-shaped guide hole 74 in communication with a mounting hole 72.

The handle receipt part 60 is formed at either end with a recessed guide 71 to guide insertion of the securing protrusion 52 into the mounting hole 72.

When the upright type vacuum cleaner is operated after being converted into the canister type, the handle 27 and the suction brush unit 22 connected with the suction pipe 29 are separated from the main body 20, and connected with a separate head 28 provided at a lower side of the suction pipe 29, as shown in FIG. 7.

As shown in FIGS. 8 and 9, when the handle 27, the suction pipe 29 connected with the handle, and a bracket for securing the suction pipe are separated from the main body 20, the main body receipt part 64 for securing the one end of the suction hose 30 is shown at a rear side of the main body 20.

The main body receipt part 64 has a cylindrical shape so as to allow the adapter 50 connected with the suction hose 30 to be inserted therein, and is formed on an inner surface thereof with the recessed guide having the funnel shape to guide insertion of the securing protrusion 52 of the adapter 50 thereinto.

The guide is cut at right and left sides thereof corresponding to border lines of the guide to form a border hole 82 such that a compression piece 80 is formed in a remaining portion of the guide cut by the border hole 82.

The compression piece 80 is formed under a lower end with a mounting hole 73 on which the securing protrusion 52 is mounted.

Operation of the installation structure of the suction hose for the upright type vacuum cleaner according to the embodiment constructed as above will be described hereinafter.

Referring to FIGS. 4 to 6, with adhesives applied onto each mounting part 32 of the suction hose 30, the mounting part 32 is coupled to the inner fastening threads 44 of the connecting member 40 in a screw fastening manner, and bonded thereto by means of the adhesives.

Then, the latching protrusion 54 of the adapter 50 is elastically fastened to the latching groove 42 of the connecting member 40, so that the connecting member 40 is prevented from being separated from the adapter 50 while being permitted to rotate on the adapter 50.

Mounting of the adapter 50 to the receipt part will be described with reference to the drawings hereinafter.

Referring to FIGS. 2 and 3, when inserting the adapter 50 into the brush receipt part 62, the securing protrusions 52 of the adapter 50 are guided along the recessed guides 70 of the brush receipt part 62, and, at this point, since the brush receipt part 62 has an inner diameter smaller than an outer diameter of the adapter 50, the adapter 50 is press-fitted into the brush receipt part 62.

If the brush receipt part 62 is further provided with a sealing structure to ensure air-tightness, mounting holes to receive the securing protrusions 52 can be formed in the brush receipt part 62 so that the securing protrusions 52 are guided along the guides 70, and secured into the mounting holes.

Next, mounting of the adapter 50 of the suction hose 30 into the handle receipt part 60 will be described hereinafter.

When the securing protrusions 52 of the adapter 50 are inserted into the mounting holes 72 along the recessed guides 71 of the handle receipt part 60, the securing protrusions 52 are turned into the guide holes 74 communicated with the mounting holes 72 so that the adapter 50 is prevented from being separated from the handle receipt part 60 during the cleaning operation.

Mounting of the adapter 50 of the suction hose 30 into the main body receipt part 64 will be described with reference to FIGS. 8 and 9 hereinafter.

When the adapter 50 is inserted into the main body receipt part 64, the securing protrusions 52 of the adapter 50 are inserted and secured into the mounting holes 73 while pushing the compression piece 80 outward, and at this point, the compression pieces 80 are resiliently bent.

With the securing protrusions 52 inserted into the mounting holes 73 as shown in FIG. 9, the compression pieces 80 return to their original shapes, thereby preventing the securing protrusions 52 from being separated from the main body receipt part 64.

Accordingly, when using the vacuum cleaner in the form of the upright type in a state wherein one end of the suction hose 30 is secured to the main body receipt part 64, the adapter 50 of the suction hose 30 is inserted into the brush receipt part 62 as shown in FIGS. 2 and 3.

In addition, when using the vacuum cleaner after converting the vacuum cleaner into the canister type vacuum cleaner, the adapter 50 is pulled and separated from the brush receipt part 62 with the suction hose 30 inserted into the main body receipt part 64, and then inserted into the handle receipt part 60 of the handle 27 such that the securing protrusions 52 of the adapter are inserted into the guide holes 74 of the handle receipt part 60, as shown in FIG. 7.

If only the mounting holes 72 are formed in the handle receipt part 60, the securing protrusions 52 inserted into the handle receipt part 60 along the guides 71 thereof can be moved outside along the guides 71 by forward and rearward actions of the handle 27, and unintentionally escaped from the handle receipt part 60.

In order to prevent this problem, the handle receipt part 60 is formed with the arc-shaped guide holes 74 communicated with the mounting holes 74 of the handle receipt part 60, so that the securing protrusions 52 inserted into the handle receipt part 60 along the guides 71 thereof move along the guide holes 74, thereby lowering likelihood of positioning the securing protrusions 52 at an entrance of the guides 71, which makes separation of the adapter easier. As a result, the suction hose 30 is prevented from being separated from the handle receipt part 60 during the cleaning operation.

Excluding the guide holes 74 of the handle receipt part 60, the main body receipt part 64, the brush receipt part 62, and the handle receipt part 60 have the similar structure, so that the adapter 50 of the suction hose 30 can be inserted and mounted to the receipt part without any directionality, thereby providing enhanced assembling efficiency.

In addition, both ends of the suction hose 30 are installed so as to rotate at 360 degrees, so that, when the suction hose 30 is subjected to a twisting force, the force is converted into a rotating force, and allows the suction hose 30 to rotate smoothly, thereby prevented from being twisted.

According to the present invention, the suction hose has a 360-degree rotation structure so that it is prevented from being twisted during a cleaning operation, thereby ensuring convenient cleaning while providing an appealing appearance.

Specifically, with the installation structure of the suction hose for the upright type vacuum cleaner, the suction hose is prevented from being twisted during the cleaning operation, so that a user can operate the vacuum cleaner without any burden on the wrist while maintaining the appealing appearance of the vacuum cleaner.

In addition, the suction hose is provided at either end with the adapter, which is applicable to the handle receipt part, the brush receipt part and the main body receipt part, so that the suction hose is assembled to an associated component without considering directionality of the suction hose, thereby allowing convenient assembling of the suction hose.

Furthermore, when using the vacuum cleaner after converting it into the canister type, the arc-shaped guide protrusions formed in the handle receipt part prevent unintentional separation of the suction hose from the handle, thereby ensuring robust mounting of the suction hose into the handle.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An installation structure of a suction hose for an upright type vacuum cleaner comprising a main body having a suction module installed therein, a dust collecting unit to suck dust and foreign substances, and a handle, the suction hose being connected at one end with the main body and at the other end with the dust collecting unit, the installation structure comprising:
a mounting part provided at either end of the suction hose and formed of a corrugated pipe having a thread shape;
a pipe-shaped connecting member secured at one end to one side of the mounting part;
an adapter having a securing protrusion formed on an outer surface thereof, and to which the connecting member is latched and secured so as to be restricted in axial movement while being permitted to rotate in a circumferential direction; and
a receipt part to which the adapter having the securing protrusion formed thereon is inserted and secured.

2. The installation structure as set forth in claim 1, wherein the connecting member has threads formed on an inner surface of one end thereof such that the mounting part is fastened to the one end of the connecting member.

3. The installation structure as set forth in claim 1, wherein the connecting member has a latching groove formed circumferentially on an outer surface thereof, and the adapter has a latching protrusion formed on an inner surface of the adapter such that the latching protrusion is inserted and mounted to the latching groove.

4. The apparatus as set forth in claim 1, wherein the receipt part comprises a recessed guide slanted in a funnel shape to guide insertion of the securing protrusion into a mounting hole of the receipt part.

5. The apparatus as set forth in claim 1, wherein the handle has a mounting hole formed therein and having an arc-shaped guide hole communicated therewith.
